(19) United States
(12) Patent Application Publication
(10) Pub. No.: US 2021/0315237 A1
(43) Pub. Date: Oct. 14, 2021

(54) SWEETENED BEVERAGE CONTAINING MINERAL-RICH WATER AND USE OF MINERAL-RICH WATER FOR THE PRODUCTION OF SWEETENED BEVERAGES

(71) Applicant: Red Bull GmbH, Fuschl am See (AT)

(72) Inventors: Josef Nachbagauer, Fuschl am See (AT); Manfred Urban-Klik, Fuschl am See (AT); Roland Concin, Fuschl am See (AT)

(21) Appl. No.: 17/261,445

(22) PCT Filed: Jul. 11, 2019
(86) PCT No.: PCT/EP2019/068714

§ 371 Date: Jan. 19, 2021

(30) Foreign Application Priority Data
Jul. 20, 2018 (EP) 18184713.8

(51) Int. Cl. A23L 2/60; A23L 33/29; A23L 27/30; A23L 33/125; A23L 29/00; A23L 2/68

(52) U.S. Cl. CPC A23L 2/60; A23L 33/29; A23L 2/68; A23L 33/125; A23L 29/035; A23L 27/34

(57) ABSTRACT

Sweetened beverages are produced with and/or substantially comprise mineral-rich water and one or more natural sweeteners. Further disclosed is the use of mineral-rich water in the production of sweetened beverages for enhancing sweet sensory impression or for enhancing sweetening power of natural sweeteners and/or for enhancing palatefulness in beverages sweetened with these natural sweeteners.

### BACKGROUND

### Technical Field

The present disclosure relates to sweetened beverages comprising mineral-rich water and to the use of mineral-rich water for the production of sweetened beverages.

### Description of the Related Art

Sucrose is often added to refreshment beverages in substantial amounts to obtain a rounded flavor profile. Refreshment beverages of this kind often have a relatively high calorie content. In soft drinks, said calorie content has previously typically been in the range of 3.6 to 3.9 kcal/g.

For a long time, a wide range of different approaches have been put forward for obtaining a pleasant degree of sweetness with lower-calorie sweeteners for any kind of beverage.

One approach for reducing the amount of sucrose required to obtain a desired degree of sweetness consists of using what are known as flavor enhancers. EP 1 977 655 B1 proposes aroma compositions of alkamides, such as pellitorines and spilanthol and hesperetin or 4-hydroxydihydroalkones, for enhancing the sweet flavor of sweet-tasting substances. Said aroma compositions are said to allow the initial sweet flavor to be enhanced.

Another approach consists of replacing sucrose with artificial sweeteners, such as aspartame, neotame, alitame, glucin, acesulfame potassium, cyclamate or saccharin, which bear no structural similarity to sucrose. Alternatively, sweeteners that are structurally derived from glucose or sucrose, such as sucralose, are also used. In the last few years, it has also been attempted to use the significant sweetening power of steviol glycosides, which can be obtained from leaves of the stevia plant, as a sucrose replacement. However, the drawback to steviol glycosides is their bitter or licorice-like aftertaste, in addition to a delayed impression of the sweet flavor. Moreover, certain mixtures of steviol glycosides sometimes produce a metallic aftertaste. A wide range of attempts are made to counteract these drawbacks, for example by using compositions of different steviol glycosides that are carefully matched to one another, as described in WO 2016/062 859 A1, or by adding flavor-modifying compounds (see also EP 2 253 226 B1). The bitter aftertaste of steviol glycosides is said to be reduced, according to WO 2012/073121 A2, by eliminating steviol glycosides rebaudioside C and dulcoside A from the used steviol glycoside extracts and, according to EP 2 474 240 A1, by using rebaudioside D, lactic acid and tartaric acid. WO 2011/146463 A2 proposes masking the bitter aftertaste of steviol glycosides by using increased amounts of rebaudioside D.

With the above-mentioned low-calorie sweeteners, the rounded flavor profile produced when sucrose is used is often not obtained. According to WO 2008/147726, a flavor impression as provided in drinks using sucrose is said to be capable of being obtained using a composition based on i) urea or thiourea as a sweetener, ii) an artificial sweetener, such as aspartame or sucralose, or stevia compounds, and iii) compounds that improve the sweetness profile, e.g., polyols or amino acids.

It would be desirable to have recourse to sweetened beverages that are no longer affected by the drawbacks of the prior art. Thus, there is accordingly a need to provide sweetened drinks which, despite using a reduced content of sucrose, have a degree of sweetness that does not differ from conventional beverages sweetened with larger amounts of sucrose. In some cases, there is accordingly a need to make available sweetened beverages which, in terms of their degree of sweetness, do not differ from conventional beverages sweetened with larger amounts of sucrose and also have a rounded flavor profile as often produced when beverages are sweetened using sucrose alone.

### BRIEF SUMMARY

Thus, the present disclosure provides a sweetened beverage having a degree of sweetness, produced with mineral-rich water and/or substantially comprising mineral-rich water and one or more natural sweeteners, in some cases comprising or consisting of sucrose.

In order to obtain the degree of sweetness in the sweetened beverage according to the present disclosure, the amount of natural sweetener, in some cases comprising or consisting of sucrose, is smaller, in some cases smaller by at least 2.0 wt. %, in some other cases smaller by at least 4.0 wt. %, in some even other cases smaller by at least 6.0 wt. %, in some further cases smaller by at least 8.0 wt. % and in some even further cases smaller by at least 10.0 wt. % than in the case of a beverage that is substantially identical to the sweetened beverage, including the degree of sweetness, except that in order to produce said beverage, no mineral-rich water, such as water having a total hardness ° dH of at most 10, in some cases less than 8.4, and in some further cases at most 7.3, was used, determined in each case in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of total hardness per liter. Thus, the sum of the concentrations of cations of alkaline earth metals in water is to be used to determine the total hardness.

### DETAILED DESCRIPTION

Within the meaning of the present disclosure, water that is not mineral-rich water is expediently understood to be water in which the mineral content of said water that is not mineral-rich water, calculated as a solid residue, is no more than 500 mg/l, in some cases no more than 50 mg/l, in accordance with Annex 6 to § 9, Section 3 of the Mineral and Table Water Regulation of the Federal Republic of Germany dated 1 Aug. 1984 (Bundesgesetzblatt, Part I, p. 1036), last modified by Article 25 of the regulation dated 5 Jul. 2017 (Bundesgesetzblatt, Part I, p. 2272).

Within the meaning of the present disclosure, mineral-rich water is in some cases understood to be water in which the mineral content of said mineral-rich water, calculated as a solid residue, is more than 1,000 mg/l, and in some cases more than 1,500 mg/l, in accordance with Appendix 6 to § 9, Section 3 of the Mineral and Table Water Regulation of the Federal Republic of Germany dated 1 Aug. 1984 (Bundesgesetzblatt, Part I, p. 1036), last modified by Article 25 of the regulation dated 5 Jul. 2017 (Bundesgesetzblatt, Part I, p. 2272). In some further cases, mineral-rich water is to be understood water that comprises at least 240 mg/l (5.988 mmol/l), in some cases 240 (5.988 mmol/l) to 360 mg/l (8.982 mmol/l), and in some further cases 270 (6.737 mmol/l) to 340 mg/l (8.483 mmol/l), calcium ions, determined in each case in accordance with EN ISO 17294-2: 2016.

In some expedient embodiments, the mineral-rich water of the sweetened beverages or the beverage according to the present disclosure comprises, in some cases additionally, at least 56 mg/l (2.304 mmol/l), in some further cases 56 (2.304 mmol/l) to 90 mg/l (3.703 mmol), and in some other cases 60 (1.234 mmol/l) to 72 mg/l (2.962 mmol/l), magnesium ions.

In further, highly expedient embodiments, the mineral-rich water of the sweetened beverages or the beverage according to the present disclosure comprises, in some cases, in addition to the above-specified amounts of calcium and/or magnesium ions, at least 150 mg/l, in some cases 150 to 300 mg/l, and in some further cases 160 to 240 mg/l, sodium ions.

In even further, highly expedient embodiments, the mineral-rich water of the sweetened beverages or the beverage according to the present disclosure comprises, in some cases, in addition to the above-specified amounts of calcium, magnesium and/or sodium ions, at least 18 mg/l, in some cases 18 to 25 mg/l, and in some further cases 21 to 24 mg/l, potassium ions.

In even further, highly expedient embodiments, the mineral-rich water of the sweetened beverages or the beverage according to the present disclosure comprises, in some cases in addition to the above-specified amounts of calcium, magnesium, sodium and/or potassium ions, at least 800 mg/l, in some cases 800 to 1,400 mg/l, and in some further cases 900 to 1,200 mg/l, hydrogen carbonate ions.

In even further, highly expedient embodiments, the mineral-rich water of the sweetened beverages or the beverage according to the present disclosure comprises, in some cases in addition to the above-specified amounts of calcium, magnesium, sodium, potassium and/or hydrogen carbonate ions, at least 3.5 mg/l, in some cases 3.8 to 6.0 mg/l and in some further cases 4.0 to 5.0 mg/l iron ions.

In even further, highly expedient embodiments, the mineral-rich water of the sweetened beverages or the beverage according to the present disclosure comprises, in some cases in addition to the above-specified amounts of calcium, magnesium, sodium, potassium, hydrogen carbonate and/or iron ions, at least 150 μg/l, in some cases 175 to 400 μg/l, and in some further cases 200 to 275 μg/l, manganese ions.

In even further, highly expedient embodiments, the mineral-rich water of the sweetened beverages or the beverage according to the present disclosure comprises, in some cases in addition to the above-specified amounts of calcium, magnesium, sodium, potassium, hydrogen carbonate, iron and/or manganese ions, at least 250 μg/l, in some cases 300 to 1,500 μg/l, and in some further cases 350 to 1,250 μg/l, lithium ions.

The present disclosure in some cases also provides sweetened beverages or beverage in which the mineral-rich water comprises at least 240 mg/l (5.988 mmol/l), in some cases 240 (5.988 mmol/l) to 360 mg/l (8.982 mmol/l), and in some further cases 270 (6.737 mmol/l) to 340 mg/l (8.483 mmol/l), calcium ions, determined in each case in accordance with EN ISO 17294-2:2016, at least 56 mg/l (2.304 mmol/l), in some cases 56 (2.304 mmol/l) to 90 mg/l (3.703 mmol/l), and in some further cases 60 (1.234 mmol/l) to 72 mg/l (2.962 mmol/l), magnesium ions, determined in each case in accordance with EN ISO 17294-2: 2016, and at least 150 mg/l, in some cases 150 to 300 mg/l, and in some further cases 160 to 240 mg/l, sodium ions, determined in each case in accordance with EN ISO 17294-2: 2016. Suitable cases include sweetened beverages or beverage in which the mineral-rich water additionally comprises at least 250 mg/l, in some cases 275 to 1,000 mg/l, and in some further cases 320 to 550 mg/l, sulfate ions, determined in each case in accordance with DIN EN ISO 10304-1: 2009-07, and/or in some cases at least 150 mg/l, in some cases 200 to 400 mg/l, and in some further cases 205 to 300 mg/l, chloride ions, determined in each case in accordance with DIN EN ISO 10304-1: 2009-07.

In at least one embodiment, mineral-rich water within the meaning of the present disclosure for the sweetened beverages according to the disclosure is water that has a total hardness ° dH of at least 20, in some cases at least 25, in some other cases at least 30, and in some other cases at least 35, in some further cases at least 40, and in some even further cases in the range of 45 to 70, and in yet some other cases in the range of 50 to 65, determined in each case in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of total hardness per liter.

In expedient embodiments, for the sweetened beverage according to the present disclosure, mineral-rich water is used that has a carbonate hardness in the range of 30 to 70, in some cases in the range of 35 to 60, and in some further cases in the range of 40 to 55 ° dH, determined in each case in accordance with DIN 38409-7: 2005-12, and/or in some cases a magnesium hardness in the range of 5 to 30, in some cases in the range of 8 to 25, and in some further cases in the range of 10 to 20 ° dH, determined in each case in accordance with DIN 38409-7: 2005-12.

The mineral-rich water of the sweetened beverages or the beverage according to the present disclosure, in some cases, has a pH value in the range of 5.5 to 7.0, in some further cases in the range of 6.0 to 6.8, and in some further cases in the range of 6.30 to 6.70, determined in each case in accordance with DIN EN ISO 10523: 2012-04.

In one embodiment, the mineral-rich water of the sweetened beverages according to the present disclosure can have a conductivity in the range of 2,000 to 3,000 μS/cm, in some cases in the range of 2,200 to 2,800 μS/cm and in some further cases in the range of 2,300 to 2,700 μS/cm, or in some cases a conductivity in the range of 2,000 to 3,000 μS/cm, in some further cases in the range of 2,200 to 2,800 μS/cm and in some further cases in the range of 2,300 to 2,700 μS/cm, determined in each case in accordance with DIN EN 27888: 1993-11.

In an advantageous configuration, the sweetened beverages according to the present disclosure comprise 250 to 500 mg/l, in some cases 300 to 450 mg/l, and in some further cases 320 to 420 mg/l, MgSO₄; 300 to 750 mg/l, in some cases 350 to 600 mg/l, and in some further cases 400 to 550 mg/l, CaCl₂; 150 to 600 mg/l, in some cases 200 to 500 mg/l, and in some further cases 275 to 400 mg/l, Na₂SO₄; and/or in some cases 600 to 1,500 mg/l, in some cases 700 to 1,400 mg/l, and in some further cases 800 to 1,100 mg/l, NaHCO₃.

In some expedient embodiments, the sweetened beverages according to the present disclosure comprise 100 to 500 mg/l, in some cases 150 to 400 mg/l, and in some further cases 200 to 300 mg/l, magnesium citrate, and/or in some cases 200 to 1,000 mg/l, in some further cases 250 to 800 mg/l, and in some further cases 300 to 650 mg/l, sodium citrate.

In some expedient embodiments, in some cases in relation to lemonades, the sweetened beverages according to the present disclosure comprise at most 7.0 wt. %, in some cases at most 6.0 wt. %, and in some further cases at most 5.5 wt. %, of a natural sweetener, in some cases comprising or consisting of sucrose.

In some further expedient embodiments, in some cases in relation to soft drinks and energy drinks, the sweetened beverages according to the present disclosure comprise at most 11.0 wt. %, in some cases at most 10.0 wt. %, and in some further cases at most 9.0 wt. %, of a natural sweetener, in some cases comprising or consisting of sucrose.

In some cases, sweetened beverages according to the present disclosure comprise at most 100 g/l sucrose, in some other cases in the range of 45 to 70 g/l sucrose, and in some further cases in the range of 50 to 60 g/l sucrose, in some cases as a single natural sweetener, and in some further cases as the only sweetener.

In expedient embodiments, natural sweeteners within the meaning of the present disclosure include monosaccharides such as selected from the group consisting of fructose, glucose, arabinonse, mannose, rhamnose, xylose, tagatose, galactose, and mixtures thereof; dissaccharides such as selected from the group consisting of sucrose, trehalose, lactose, maltose, and mixtures thereof; sweet-tasting sugar alcohols such as selected from the group consisting of ervthritol, glycerol, lactitol, maltitol, mannitol, sorbitol, xylitol, galactitol, and mixtures thereof; and steviol glycosides such as selected from the group consisting of rebaudiosides, steviosides, steviolbiosides, rubusosides, dulcoside, enzymatically modified steviol glycosides, and mixtures thereof. Natural sweeteners within the meaning of the present disclosure, in some cases, are disaccharides, in some further cases sucrose.

Sweetened beverages according to the present disclosure can further comprise at least one artificial sweetener, such as selected from the group consisting of aspartame, sucralose, neotame, alitame, glucin, acesulfame potassium, cyclamate, saccharin, neohesperidin dihydrochalcone, and mixtures thereof.

The sweetened beverages according to the present disclosure can also comprise taurine and/or caffeine.

Moreover, thaumatin, phloretin, trilobatin, monatin, and/or hesperetin can be added as flavor enhancers.

The sweetened beverages according to the present disclosure can be carbon-dioxide-containing soft drinks, in some cases having a cola or fruit flavor, energy drinks, or lemonades, or be used to produce beverages of this kind.

The present disclosure also provides the use of mineral-rich water, such as specified above in general and in detail, in the production of sweetened beverages for enhancing the sweet sensory impression or for enhancing the sweetening power of natural sweeteners, in some cases comprising or consisting of sucrose, and/or for enhancing palatefulness, in some cases for enhancing the sweetening power, in beverages sweetened with said natural sweeteners.

Said mineral-rich water is in some cases used to produce beverages sweetened with natural sweeteners, such as lemonades, in some cases comprising or consisting of sucrose, said beverages having a reduced sugar content. A lemonade within the meaning of the present disclosure is to be understood to be an alcohol-free, sweetened refreshment beverage, optionally with carbon dioxide added thereto, comprising water-based fruit extracts.

The present disclosure makes it possible to obtain sweetened beverages having a reduced content of natural sweetener, in some cases comprising or consisting of sucrose, said beverages having a degree of sweetness that is comparable with the degree of sweetness of beverages sweetened with said natural sweeteners, in some cases comprising or consisting of sucrose, said beverages being produced with water that is not mineral-rich water, such as water having a total hardness ° dH of at most 10, in some cases less than 8.4, and in some further cases at most 7.3, determined in each case in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of total hardness per liter.

Thus, the use of mineral-rich water, such as defined above in general and in detail, for the reduction of the content of natural sweeteners, in some cases comprising or consisting of sucrose, in sweetened beverages, such as lemonades, in some cases without having to tolerate a reduction in the degree of sweetness, was also discovered. The present disclosure led to the surprising finding that the use of mineral-rich water within the meaning of the present disclosure makes it possible to enhance the sensory impression of the sweetness of beverages sweetened with natural sweeteners, in some cases comprising or consisting of sucrose, it also being possible to achieve a palateful or more palateful impression of flavor. A palateful impression of flavor is known of malt-containing beverages, for example. It is also surprising that the mineral-rich water within the meaning of the present disclosure also makes it possible to enhance the sweetness of natural sweeteners in the case of energy drinks and to also bring about a palateful or more palateful impression of flavor.

The features of the present disclosure disclosed in the above description and in the claims may be essential either individually or in any desired combination for carrying out the various embodiments of the present disclosure.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A sweetened beverage having a degree of sweetness, produced with and/or substantially comprising mineral-rich water and one or more natural sweeteners.

2. The sweetened beverage according to claim 1, wherein to obtain the degree of sweetness, the amount of natural sweetener is smaller than in the case of a beverage that is substantially identical to the sweetened beverage, including the degree of sweetness, except that in order to produce said beverage, no mineral-rich water was used.

3. The sweetened beverage according to claim 2, wherein the mineral content of water that is not mineral-rich water, calculated as a solid residue, is no more than 500 mg/l or no more than 50 mg/l.

4. The sweetened beverage according to claim 1, wherein the mineral-rich water or the beverage comprises at least 240 mg/l calcium ions, determined in accordance with EN ISO 17294-2: 2016, and/or at least 56 mg/l magnesium ions, determined in accordance with EN ISO 17294-2: 2016, and/or at least 150 mg/l, sodium ions, determined in accordance with EN ISO 17294-2: 2016.

5. The sweetened beverage according to claim 1, wherein the mineral-rich water or the beverage comprises at least 250 mg/l sulfate ions, determined in accordance with DIN EN ISO 10304-1: 2009-07, and/or at least 150 mg/l chloride ions, determined min accordance with DIN EN ISO 10304-1: 2009-07.

6. The sweetened beverage according to claim 1, wherein the mineral-rich water or the beverage comprises:
at least 240 mg/l, calcium ions, determined in accordance with EN ISO 17294-2: 2016,
at least 56 mg/l magnesium ions, determined in each case in accordance with EN ISO 17294: 2016, and
at least 150 mg/l sodium ions, determined in accordance with EN ISO 17294-2: 2016.

7. The sweetened beverage according to claim 1, wherein the mineral-rich water or the beverage, comprises:
at least 18 mg/l, potassium ions, determined in accordance with EN ISO 17294-2: 2016, and/or
at least 3.5 mg/l iron ions, determined in accordance with EN ISO 17294-2:2 016, and/or
at least 150 μg/l manganese ions, determined in accordance with EN ISO 17294-2: 2016, and/or
at least 250 μg/l, lithium ions, determined in accordance with EN ISO 17294-2: 2016, and/or
at least 800 mg/l, hydrogen carbonate ions, determined in accordance with DIN 38409-7: 2005-12.

8. The sweetened beverage according to any claim 1, wherein the mineral-rich water or the beverage has a pH value in the range of 5.5 to 7.0, determined in accordance with DIN EN ISO 10523: 2012-04, and/or a conductivity in the range of 2,000 to 3,000 μS/cm, in accordance with DIN EN 27888: 1993-11.

9. The sweetened beverage according to claim 1, wherein the mineral-rich water or the beverage has a total hardness ° dH of at least 35 determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter.

10. The sweetened beverage according to claim 1, wherein the mineral-rich water or the beverage has a carbonate hardness in the range of 30 to 70 determined in accordance with DIN 38409-7: 2005-12, and/or a magnesium hardness in the range of 5 to 30 ° dH, determined in accordance with DIN 38409-7: 2005-12.

11. The sweetened beverage according to claim 1, comprising:
250 to 500 mg/l MgSO₄,
300 to 750 mg/l CaCl₂,
150 to 600 mg/l, Na₂SO₄, and/or
600 to 1,500 mg/l NaHCO₃.

12. The sweetened beverage according to claim 1, further comprising citric acid and/or citrates.

13. The sweetened beverage according to claim 1, wherein the mineral content of the mineral-rich water, calculated as a solid residue, is more than 1,000 mg/l.

14. The sweetened beverage according to claim 1, comprising:
at most 7.0 wt. %, of the natural sweetener.

15. The sweetened beverage according to claim 1, comprising:
at most 100 g/l sucrose.

16. The sweetened beverage according claim 1, wherein:
the natural sweeteners include monosaccharides, disaccharides, sweet-tasting sugar alcohols, and/or steviol glycosides.

17. The sweetened beverage according to claim 1, further comprising at least one artificial sweetener.

18. The sweetened beverage according to claim 1, wherein said sweetened beverage is a soft drink, an energy drink, or a lemonade.

19. The sweetened beverage according to claim 1, wherein the mineral-rich water has a total hardness ° dH of at least 35, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, wherein in order to obtain the degree of sweetness, the amount of natural sweetener is smaller than in the case of a beverage that is substantially identical to the sweetened beverage, including the degree of sweetness, except that in order to produce said beverage, water having a total hardness ° dH of at most 10 was used, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter.

20. The sweetened beverage according to claim 1, wherein:
in order to obtain the degree of sweetness, the amount of natural sweetener is smaller than in the case of a beverage that is substantially identical to the sweetened beverage, including the degree of sweetness, except that in order to produce said beverage, water having a total hardness ° dH of at most 10, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, and
wherein the mineral-rich water or the beverage comprises:
at least 240 mg/l calcium ions, determined in accordance with EN ISO 17294-2: 2016,
at least 56 mg/l magnesium ions, determined in accordance with EN ISO 17294-2: 2016, and
at least 150 mg/l sodium ions, determined in accordance with EN ISO 17294-2: 2016.

21. The sweetened beverage according to claim 1, wherein the mineral-rich water has a total hardness ° dH of at least 35, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter,
wherein in order to obtain the degree of sweetness, the amount of natural sweetener is smaller than in the case of a beverage that is substantially identical to the sweetened beverage, including the degree of sweetness, except that in order to produce said beverage, water having a total hardness ° dH of at most 10 was used, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, and
wherein the mineral-rich water or the beverage, comprises at least 240 mg/l calcium ions, determined in accordance with EN ISO 17294-2: 2016.

22. The sweetened beverage according to claim 1, wherein the mineral-rich water has a total hardness ° dH of at least 35, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, wherein in order to obtain the degree of sweetness, the amount of natural sweetener such as comprising or consisting of sucrose, is smaller than in the case of a beverage that is substantially identical to the sweetened beverage, including the degree of sweetness, except that in order to produce said beverage, water having a total hardness ° dH of at most 10 was used, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, and
wherein the mineral-rich water or the beverage comprises at least 56 mg/1 magnesium ions, determined in accordance with EN ISO 17294-2: 2016.

23. The sweetened beverage according to claim 1, wherein the mineral-rich water has a total hardness ° dH of at least 35, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, wherein in order to obtain the degree of sweetness, the amount of natural sweetener is smaller than in the case of a beverage that is substantially identical to the sweetened beverage, including the degree of sweetness, except that in order to produce said beverage, water having a total hardness ° dH of at most 10 was used, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, and
wherein the mineral-rich water or the beverage comprises at least 150 mg/l sodium ions, determined in accordance with EN ISO 17294-2: 2016.

24. The sweetened beverage according to claim 1, wherein the mineral-rich water has a total hardness ° dH of at least 35, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, wherein in order to obtain the degree of sweetness, the amount of natural sweetener is smaller than in the case of a beverage that is substantially identical to the sweetened beverage, including the degree of sweetness, except that in order to produce said beverage, water having a total hardness ° dH of at most 10 was used, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter. and
wherein the mineral-rich water or the beverage comprises at least 240 mg/l calcium ions, determined in accordance with EN ISO 17294-2: 2016, and at least 56 mg/l magnesium ions, determined in accordance with EN ISO 17294-2: 2016.

25. The sweetened beverage according to claim 1, wherein the mineral-rich water has a total hardness ° dH of at least 35, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, and
wherein the mineral-rich water or the beverage comprises at least 240 mg/l calcium ions, determined in accordance with EN ISO 17294-2: 2016, and at least 56 mg/l magnesium ions, determined in each case in accordance with EN ISO 17294-2: 2016.

26. The sweetened beverage according to claim 1, wherein the mineral-rich water has a total hardness ° dH of at least 35, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, wherein in order to obtain the degree of sweetness, the amount of natural sweetener is smaller than in the case of a beverage that is substantially identical to the sweetened beverage, including the degree of sweetness, except that in order to produce said beverage, water having a total hardness ° dH of at most 10 was used, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter, and
wherein the mineral-rich water or the beverage comprises at least 240 mg/l calcium ions, determined in accordance with EN ISO 17294-2: 2016, at least 56 mg/l magnesium ions, determined in accordance with EN ISO 17294-2: 2016, and at least 150 mg/l sodium ions, determined in accordance with EN ISO 17294-2: 2016.

27. A use of mineral-rich water in the production of sweetened beverages for enhancing the sweet sensory impression or for enhancing the sweetening power of natural sweeteners and/or for enhancing palatefulness in beverages sweetened with said natural sweeteners.

28. The use according to claim 27, of mineral-rich water for the production of beverages sweetened with natural sweeteners, said beverages having a reduced sugar content.

29. The use according to claim 27, wherein the sweetened beverages having a reduced content of natural sweetener have a degree of sweetness that is comparable with the degree of sweetness of beverages sweetened with said natural sweeteners, said beverages being produced with water having a total hardness ° dH of at most 10, determined in each case in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter.

30. A use of mineral-rich water for reducing the content of natural sweeteners in sweetened beverages.

31. The sweetened beverage according to claim 1, wherein the one or more natural sweeteners comprise sucrose.

32. The sweetened beverage according to claim 2, wherein the natural sweetener comprises sucrose.

33. The sweetened beverage according to claim 2, wherein the amount of natural sweetener is smaller by at least 2.0 wt. %.

34. The sweetened beverage according to claim 2, wherein the water being not mineral-rich water has a total hardness ° dH of at most 10, determined in accordance with the Washing and Cleaning Agents Act (WRMG) of the Federal Republic of Germany, in the version that came into effect on 5 May 2007, subject to mentions of millimoles of calcium carbonate per liter that are provided in said act being replaced with millimoles of cations of alkaline earth metals per liter.

35. The sweetened beverage according to claim 4, wherein the mineral-rich water or the beverage comprises:
240 to 360 mg/l calcium ions, determined in accordance with EN ISO 17294-2: 2016, and/or
56 to 90 mg/l magnesium ions, determined in accordance with EN ISO 17294-2: 2016, and/or
150 to 300 mg/l sodium ions, determined in accordance with EN ISO 17294-2: 2016.

36. The sweetened beverage according to claim 5, wherein the mineral-rich water or the beverage comprises:
275 to 1,000 mg/l sulfate ions, determined in accordance with DIN EN ISO 10304-1: 2009-07, and/or
200 to 400 mg/l chloride ions, determined in accordance with DIN EN ISO 10304-1: 2009-07

37. The sweetened beverage according to claim 6, wherein the mineral-rich water or the beverage comprises:
240 to 360 mg/l calcium ions, determined in accordance with EN ISO 17294-2: 2016,
56 to 90 mg/l magnesium ions, determined in accordance with EN ISO 17294: 2016, and
150 to 300 mg/l sodium ions, determined in accordance with EN ISO 17294-2: 2016.

38. The sweetened beverage according to claim 6, further comprising:
at least 250 mg/l sulfate ions, determined in accordance with DIN EN ISO 10304-1: 2009-07, and/or
at least 150 mg/l chloride ions, determined in accordance with DIN EN ISO 10304-1: 2009-07.

39. The sweetened beverage according to claim 7, wherein the mineral-rich water or the beverage comprises:
18 to 25 mg/l potassium ions, determined in accordance with EN ISO 17294-2: 2016, and/or
3.8 to 6.0 mg/l iron ions, determined in accordance with EN ISO 17294-2: 2016, and/or
175 to 400 μg/l manganese ions, determined in accordance with EN ISO 17294-2: 2016, and/or
300 to 1,500 μg/l lithium ions, determined in accordance with EN ISO 17294-2: 2016, and/or
800 to 1,400 mg/l hydrogen carbonate ions, determined in accordance with DIN 38409-7: 2005-12.

40. The sweetened beverage according to claim 9, wherein the mineral-rich water or the beverage has a total hardness ° dH of at least 40 or in the range of 45 to 70.

41. The sweetened beverage according to claim 1, further comprising magnesium citrate and/or sodium citrate.

42. The sweetened beverage according to claim 1, further comprising 100 to 500 mg/l magnesium citrate and/or 200 to 1,000 mg/l sodium citrate.

43. The sweetened beverage according to claim 1, comprising in the range of 45 to 70 g/l sucrose.

44. The sweetened beverage according to claim 16, wherein the monosaccharides are selected from the group consisting of fructose, glucose, arabinose, mannose, rhamnose, xylose, tagatose, galactose, and mixtures thereof, or wherein the disaccharides are selected from the group consisting of trehalose, lactose, maltose, and mixtures thereof, or
wherein the sweet-tasting sugar alcohols are selected from the group consisting of erythritol, glycerol, lactitol, maltitol, mannitol, sorbitol, xylitol, galactitol, and mixtures thereof, or
wherein the steviol glycosides are selected from the group consisting of rebaudiosides, steviosides, steviolbiosides, rubusosides, dulcosides, enzymatically modified steviol glycosides, and mixtures thereof.

45. The sweetened beverage according to claim 16, wherein the at least one artificial sweetener is selected from the group consisting of aspartame, sucralose, neotame, alitame, glucin, acesulfame potassium, cyclamate, saccharin, neohesperidin dihydrochalcone, and mixtures thereof.

46. The sweetened beverage according to claim 1, further comprising taurine and/or caffeine.

47. The sweetened beverage according to claim 1, further comprising thaumatin, phloretin, trilobatin, monatin, and/or hesperetin.

48. The sweetened beverage according to claim 18, wherein said sweetened beverage is a carbon-dioxide-containing soft drink or a carbon-dioxide-containing energy drink.

49. The sweetened beverage according to claim 25, further comprising at least 150 mg/l sodium ions, determined in accordance with EN ISO 17294-2: 2016.
